(19) United States
(12) Patent Application Publication
(10) Pub. No.: US 2026/0237930 A1
(43) Pub. Date: Aug. 13, 2026

(54) POWER TERMINAL HAVING A CONTACT INSERT

(71) Applicant: TE Connectivity Solutions GmbH, Schaffhausen (CH)

(72) Inventor: Adam Price Tyler, Troy, MI (US)

(21) Appl. No.: 19/177,944

(22) Filed: Apr. 14, 2025

Related U.S. Application Data
(60) Provisional application No. 63/757,425, filed on Feb. 12, 2025.

(51) Int. Cl. H01R 13/11; H01R 13/42

(52) U.S. Cl. CPC H01R 13/113; H01R 13/42

(57) ABSTRACT

A power terminal includes a main body extending between a front and a rear and having a terminating portion configured to be terminated to a power conductor. The power terminal includes an outer terminal body extending from the main body with walls forming a socket and with a front opening open to the socket configured to receive a mating power terminal. The power terminal includes a contact insert received in the socket including a contact body electrically connected to the outer terminal body. The contact body forms a receptacle configured to receive the mating power terminal and contact beams extending into the receptacle to interface with the mating power terminal to electrically connect the outer terminal body to the mating power terminal. The outer terminal body is pre-formed to form the socket prior to receiving the contact insert. The contact insert is pre-formed prior to loading into the socket.

### CROSS REFERENCE TO RELATED APPLICATIONS

This application claims priority to U.S. Application No. 63/757,425, filed 12 Feb. 2025, the subject matter of which is herein incorporated by reference in its entirety.

### BACKGROUND OF THE INVENTION

The subject matter herein relates generally to power terminals.

Power terminals are used to transmit power between various components. Power terminals typically have a separable interface to allow mating and unmating of the power terminals. For example, one of the power terminals may include a socket and the other power terminal may include a pin or tab configured to be plugged into the socket. The socket terminal typically includes one or more spring beams defining the mating interface configured to mate with the tab terminal. Large stock or thick terminals are difficult to form spring beams. As such, some known power terminals include an outer terminal body made from large stock material and an inner contact body coupled to the outer terminal body and made from a smaller stock material. The inner contact body may be stamped and formed to include the spring beams. The inner contact body is typically connected to the outer contact body by welding, riveting, or otherwise forming a permanent electrical connection therebetween.

Known power terminals are not without disadvantages. For instance, the parts are typically assembled with the outer terminal body in a pre-formed or open state and then the combined assembly is formed into the socket shape. The result is that the critical contact gap dimension is dependent on an imprecise closure forming operation of the terminal body. Contact gap vision inspection of the formed socket terminal can be challenging with the terminal body in the formed state. For example, internal portions of the terminal are obstructed from view.

A need remains for a robust power terminal that can be manufactured in a cost effective and reliable manner.

### BRIEF DESCRIPTION OF THE INVENTION

In one embodiment, a power terminal is provided and includes a main body that extends between a front and a rear. The power terminal includes a terminating portion that extends from the main body configured to be terminated to a power conductor. The power terminal includes an outer terminal body that extends from the main body. The outer terminal body has an upper wall, a lower wall, and side walls form a socket. The outer terminal body includes a front opening open to the socket. The front opening is configured to receive a mating power terminal. The power terminal includes a contact insert received in the socket. The contact insert includes a contact body electrically connected to the outer terminal body. The contact body forms a receptacle configured to receive the mating power terminal. The contact insert includes contact beams that extend into the receptacle to interface with the mating power terminal to electrically connect the outer terminal body to the mating power terminal. The outer terminal body is pre-formed to form the socket prior to receiving the contact insert. The contact insert is pre-formed prior to loading into the socket.

In another embodiment, a power terminal is provided and includes a main body that extends between a front and a rear. The power terminal includes a terminating portion that extends from the main body configured to be terminated to a power conductor. The power terminal includes an outer terminal body that extends from the main body. The outer terminal body has an upper wall, a lower wall, and side walls form a socket. The outer terminal body includes a front opening open to the socket at the front and a rear opening open to the socket at the rear. The front opening is configured to receive a mating power terminal. The power terminal includes a front contact insert received in the socket. The front contact insert includes a front contact body electrically connected to the outer terminal body. The front contact body forms a front receptacle configured to receive the mating power terminal. The front contact insert includes front contact beams that extend into the front receptacle to interface with the mating power terminal to electrically connect the outer terminal body to the mating power terminal. The power terminal includes a rear contact insert received in the socket. The rear contact insert includes a rear contact body electrically connected to the outer terminal body. The rear contact body forms a rear receptacle configured to receive the mating power terminal. The rear contact insert includes rear contact beams that extend into the rear receptacle to interface with the mating power terminal to electrically connect the outer terminal body to the mating power terminal. The outer terminal body is pre-formed to form the socket prior to receiving the front and rear contact inserts. The front contact insert is pre-formed prior to loading into the socket. The rear contact insert is pre-formed prior to loading into the socket.

In a further embodiment, a method of forming a power terminal is provided. The method provides a main body with a terminating portion that extends from the main body configured to be terminated to a power conductor. The main body is a metal structure. The main body extends between a front and a rear. The method forms an outer terminal body from the main body by a forms process to define a socket. The outer terminal body has an upper wall, a lower wall, and side walls surrounding the socket. The outer terminal body includes a front opening open to the socket configured to receive a mating power terminal. The method provides a contact body that includes contact beams. The method forms the contact body into a contact insert has a receptacle configured to receive the mating power terminal. The contact beams extend into the receptacle to interface with the mating power terminal. The method loads the formed contact insert into the socket of the formed outer terminal body. The method electrically connects the contact insert to the outer body terminal to electrically connect the outer terminal body to the mating power terminal.

### BRIEF DESCRIPTION OF THE DRAWINGS

FIG. 1 illustrates an electrical connector system including a power terminal in accordance with an exemplary embodiment.

FIG. 2 is a front perspective, exploded view of the power terminal in accordance with an exemplary embodiment.

FIG. 3 is a front perspective, assembled view of the power terminal in accordance with an exemplary embodiment.

FIG. 4 is a front perspective view of the contact insert in accordance with an exemplary embodiment.

FIG. 5 is a front perspective view of the contact insert in accordance with an exemplary embodiment.

FIG. 6 is a top, partial sectional view of the contact insert in accordance with an exemplary embodiment.

FIG. 7 is a front view of the contact insert in accordance with an exemplary embodiment.

FIG. 8 is a cross-sectional view of the power terminal in accordance with an exemplary embodiment.

FIG. 9 is a cross-sectional view of the power terminal in accordance with an exemplary embodiment showing the mating power terminal mated with the power terminal.

FIG. 10 illustrates the electrical connector system including the power terminal in accordance with an exemplary embodiment.

FIG. 11 is a front perspective, exploded view of the power terminal in accordance with an exemplary embodiment.

FIG. 12 is a front perspective, assembled view of the power terminal 200 in accordance with an exemplary embodiment.

FIG. 13 is a front perspective, exploded view of the power terminal in accordance with an exemplary embodiment.

FIG. 14 is a front perspective, assembled view of the power terminal in accordance with an exemplary embodiment.

FIG. 15 is a front perspective, exploded view of the power terminal in accordance with an exemplary embodiment.

FIG. 16 is a front perspective, assembled view of the power terminal in accordance with an exemplary embodiment.

FIG. 17 is a side cross-sectional view of the power terminal in accordance with an exemplary embodiment.

FIG. 18 is an end cross-sectional view of the power terminal in accordance with an exemplary embodiment.

### DETAILED DESCRIPTION OF THE INVENTION

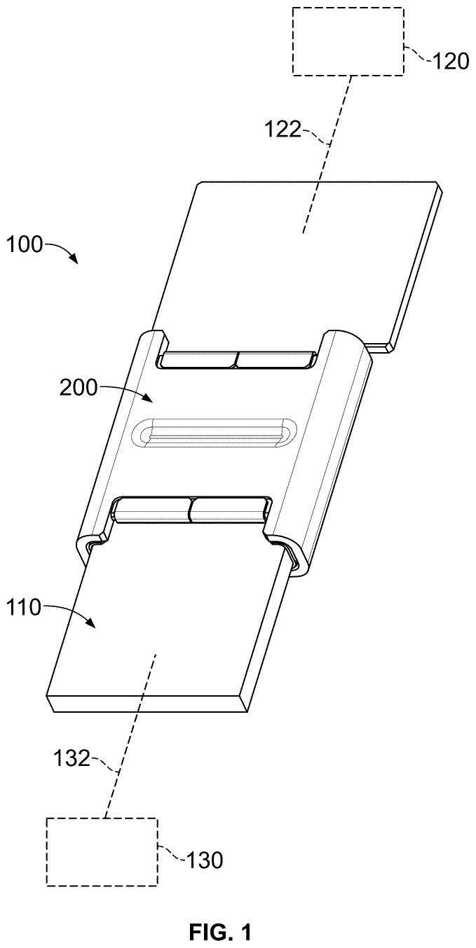

FIG. 1 illustrates an electrical connector system 100 including a power terminal 200 in accordance with an exemplary embodiment. The electrical connector system 100 includes a mating power terminal 110 coupled to the power terminal 200 at a separable mating interface. For example, the mating power terminal 110 may be plugged into the power terminal 200 to create an electrical connection and transmit power therebetween.

The mating power terminal 110 is configured to be coupled to an electrical component 120. For example, the mating power terminal 110 may be directly connect to the electrical component 120. In other embodiments, the mating power terminal 110 may be connected to the electrical component 120 by a power conductor 122, such as a power cable, a busbar, or other type of power conductor. The electrical component 120 may be a machine, device, or system that supplies or receives power. For example, the electrical component 120 may be a power supply device. In other various embodiments, the electrical component 120 may be a motor or other type of powered device. In other various embodiments, the electrical component 120 may be a battery that is charged via the connection with the power terminal 200. In the illustrated embodiment, the mating power terminal 110 is a blade terminal. For example, the mating power terminal 110 is a flat metal plate. Other types of terminals may be used in alternative embodiment, such as a pin, a tab, a spring beam, or other type of mating terminal.

The power terminal 200 is configured to be coupled to an electrical component 130. The first and second electrical components 120, 130 are electrically connected through the power terminal 200 and the mating power terminal 110. In an exemplary embodiment, the power terminal 200 may be directly connect to the electrical component 130. In other embodiments, the power terminal 200 may be connected to the electrical component 130 by a power conductor 132, such as a power cable, a busbar, or other type of power conductor. The electrical component 120 may be a machine, device, or system that supplies or receives power. For example, the electrical component 120 may be a power supply device. In other various embodiments, the electrical component 120 may be a motor or other type of powered device. In other various embodiments, the electrical component 120 may be a battery that is charged via the connection with the mating power terminal 110. In the illustrated embodiment, the power terminal 200 is a socket terminal. For example, the power terminal 200 includes a metal, box-shaped structure that forms a socket configured to receive the mating power terminal 110.

In an exemplary embodiment, the power terminal 200 is a multi-piece terminal structure. For example, the power terminal 200 includes an outer terminal body and an inner terminal body. The inner terminal body is configured to electrically connect to the mating power terminal 110. The outer terminal body is configured to electrically connect to the electrical component 130 and/or the conductor (cable, busbar, etc.). The inner and outer terminal bodies are separately manufactured and coupled together to create the terminal structure. As such, the inner and outer terminal bodies may be manufactured by separate processes, from separate materials, to different specifications, and the like to improve characteristics of the power terminal 200, such as manufacturing cost, robustness, conductivity, ease of manufacture, manufacturing tolerance, and the like.

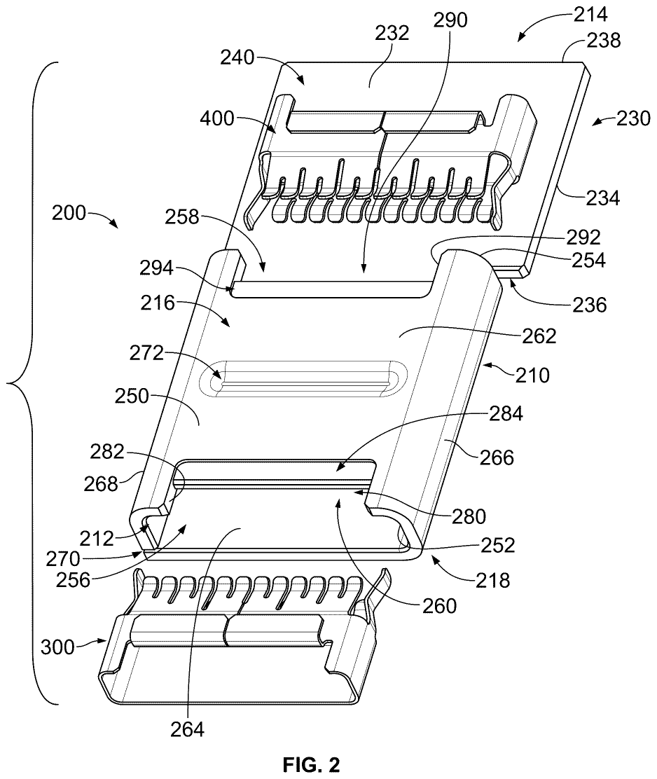

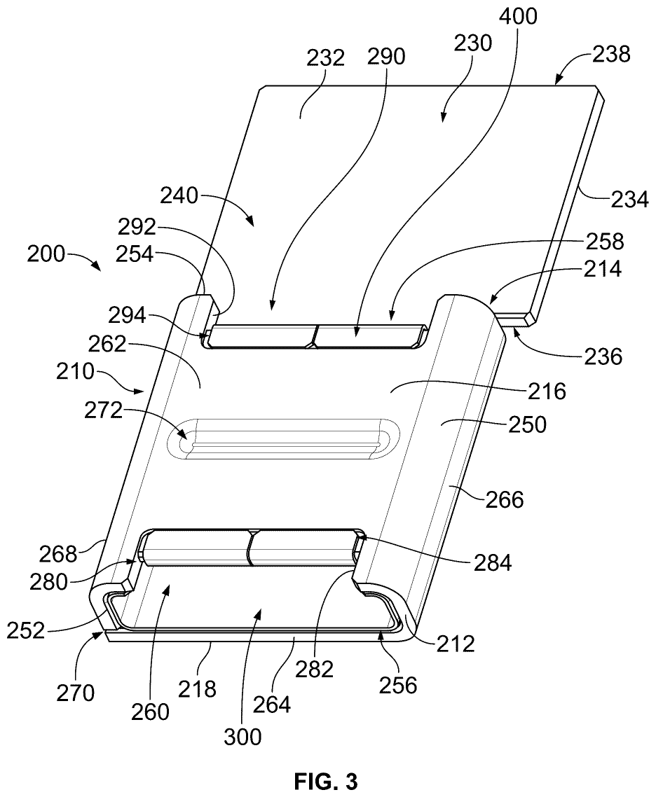

FIG. 2 is a front perspective, exploded view of the power terminal 200 in accordance with an exemplary embodiment. FIG. 3 is a front perspective, assembled view of the power terminal 200 in accordance with an exemplary embodiment.

The power terminal 200 includes a main body 210, a terminating portion 230 extending from the main body 210, and an outer terminal body 250 extending from the main body 210. The power terminal 200 includes a front contact insert 300 received in the outer terminal body 250. The power terminal 200 may additionally or alternatively, include a rear contact insert 400 received in the outer terminal body 250. In an exemplary embodiment, the outer terminal body 250 is pre-formed to form a socket prior to receiving the front contact insert 300 and/or the rear contact insert 400. The front contact insert 300 is pre-formed prior to loading into the socket of the outer terminal body 250. The rear contact insert 400 is pre-formed prior to loading into the socket of the outer terminal body 250.

In an exemplary embodiment, the main body 210 extends between a front 212 and a rear 214. The main body 210 includes a top 216 and a bottom 218. In an exemplary embodiment, the main body 210 is a metal plate. For example, the main body 210 may be a copper plate, aluminum plate, or other metal plate. The main body 210 may be a stamped metal part. The main body 210 has a thickness. The main body may have a uniform thickness, such as being stamped from a metal plate having parallel upper and lower surfaces defining the thickness.

In an exemplary embodiment, the terminating portion 230 and/or the outer terminal body 250 is formed from the main body 210. For example, a portion of the main body 210 may be stamped to define the terminating portion 230. In other embodiments, the terminating portion 230 may be formed into a non-planar shape from a portion of the main body 210. A portion of the main body 210 may be stamped to define the terminal body 250. The terminal body 250 may be formed into a non-planar shape (for example, a socket) from a portion of the main body 210.

The terminating portion 230 extends from the main body 210. The terminating portion 230 may be integral with the main body 210. For example, the terminating portion 230 may be stamped from a portion of the main body 210. The terminating portion 230 may have the thickness defined by the main body 210. The terminating portion 230 is configured to be terminated to the power conductor 132 (FIG. 1). The terminating portion 230 includes an upper surface 232 and a lower surface 234. The terminating portion 230 includes a fixed end 236 at the main body 210 and/or at the outer terminal body 250. The terminating portion 230 includes a distal end 238 opposite the fixed end 236. In the illustrated embodiment, the terminating portion 230 is in-line with the outer terminal body 250, such as extending longitudinally with the outer terminal body 250. For example, the terminating portion 230 may be aligned with the socket. In the illustrated embodiment, the terminating portion 230 is provided at the rear 214 of the power terminal 200. For example, the terminating portion 230 extends rearward from the outer terminal body 250. Other orientations are possible in alternative embodiments, such as a 90° or right angle orientation having the terminating portion 230 extending laterally, such as from a side of the outer terminal body 250.

In an exemplary embodiment, the terminating portion 230 includes a weld pad 240 configured to be welded to the power conductor 132. For example, the power conductor may be a power cable configured to be welded to the weld pad 240 or a busbar configured to be welded to the weld pad 240. Other types of terminations may be used in alternative embodiments, such as a crimp connection, a compression connection, a bolted connection, or another type of electrical connection.

The outer terminal body 250 extends from the main body 210. The outer terminal body 250 may be integral with the main body 210. For example, the outer terminal body 250 may be stamped from a portion of the main body 210 and formed into a particular shape. For example, the outer terminal body 250 may be formed into a box-shape to form a socket 260. The outer terminal body 250 may have the thickness defined by the main body 210. For example, the walls of the outer terminal body 250 may have the thickness. The outer terminal body 250 is configured to be electrically connected to the mating power terminal 110 (FIG. 1) via the front contact insert 300 and/or the rear contact insert 400.

The outer terminal body 250 extends between a front end 252 and a rear end 254. The front end 252 may be located at the front 212 of the power terminal 200. The rear end 254 may be located at the rear 214 of the power terminal 200. Alternatively, the terminating portion 230 may be located rearward of the outer terminal body 250. For example, the terminating portion 230 may extend rearward from the rear end 254 of the outer terminal body 250. In an exemplary embodiment, the outer terminal body 250 includes a front opening 256 at the front end 252. The front opening 256 is open to the socket 260. In an exemplary embodiment, the outer terminal body 250 includes a rear opening 258 at the rear end 254. The rear opening 258 is open to the socket 260.

In an exemplary embodiment, the outer terminal body 250 is bent or folded or otherwise formed into the box-shape to form the socket 260. The outer terminal body 250 includes a plurality of walls forming the box-shaped structure to surround the socket 260. In an exemplary embodiment, the outer terminal body 250 includes an upper wall 262, a lower wall 264, and side walls 266, 268 extending between the upper and lower walls 262, 264. The walls extend between the front end 252 and the rear end 254. The upper wall 262 is located above the socket 260. The lower wall 264 is located below the socket 260. The side walls 266, 268 are located at opposite sides of the socket 260.

In an exemplary embodiment, the lower wall 264 is coplanar with the main body 210 and/or the terminating portion 230. For example, the terminating portion 230 may extend from the lower wall 264. The side walls 266, 268 and the upper wall 262 may be formed by a flap that is folded over the lower wall 264 into the box-shape. For example, the first side wall 266 may be bent from the lower wall 264, the upper wall 262 may be bent from the first side wall 266, and the second side wall 268 may be bent from the upper wall 262 toward the lower wall 264. The second side wall 268 may meet the lower wall 264 at a seam 270. The second side wall 268 may be welded to the lower wall 264 at the seam 270. Other arrangements are possible in alternative embodiments, such as having the first and second side walls 266, 268 being bent from opposite sides of the lower wall 264 and with the seam 270 being provided at the upper wall 262, such as along a centerline of the upper wall 262.

In an exemplary embodiment, the outer terminal body 250 includes a dimple 272 extending into the socket 260. The dimple(s) 272 may be provided in the upper wall 262 and/or the lower wall 264. The dimple(s) 272 may extend laterally, such as between the first and second sides. The dimple(s) 272 may be used to control a position of the mating power terminal 110 in the socket 260, such as to control a position of the mating power terminal 110 relative to the contact inserts 300, 400. The dimple(s) 272 may limit overstress of the contact beams of the contact inserts 300, 400, such as by controlling a vertical position of the mating power terminal 110 in the socket 260.

In an exemplary embodiment, the outer terminal body 250 includes a front slot 280 at the front end 252. The front slot 280 is configured to receive a portion of the front contact insert 300. In the illustrated embodiment, the front slot 280 is provided in the upper wall 262. The front slot 280 may additionally or alternatively be provided in the lower wall 264 and/or the side walls 266, 268. The front slot 280 includes edges 282 extending along sides of the front slot 280. In an exemplary embodiment, the outer terminal body 250 includes a front pocket 284 at the front end 252. The front pocket 284 is configured to receive a portion of the front contact insert 300. In the illustrated embodiment, the front pocket 284 is provided in the upper wall 262. The front pocket 284 may be formed by thinning or removing a portion of the upper wall 262. The front pocket 284 may be located in the front slot 280.

In an exemplary embodiment, the outer terminal body 250 includes a rear slot 290 at the rear end 254. The rear slot 290 is configured to receive a portion of the rear contact insert 400. In the illustrated embodiment, the rear slot 290 is provided in the upper wall 262. The rear slot 290 may additionally or alternatively be provided in the lower wall 264 and/or the side walls 266, 268. The rear slot 290 includes edges 292 extending along sides of the rear slot 290. In an exemplary embodiment, the outer terminal body 250 includes a rear pocket 294 at the rear end 254. The rear pocket 294 is configured to receive a portion of the rear contact insert 400. In the illustrated embodiment, the rear pocket 294 is provided in the upper wall 262. The rear pocket 294 may be formed by thinning or removing a portion of the upper wall 262. The rear pocket 294 may be located in the rear slot 290.

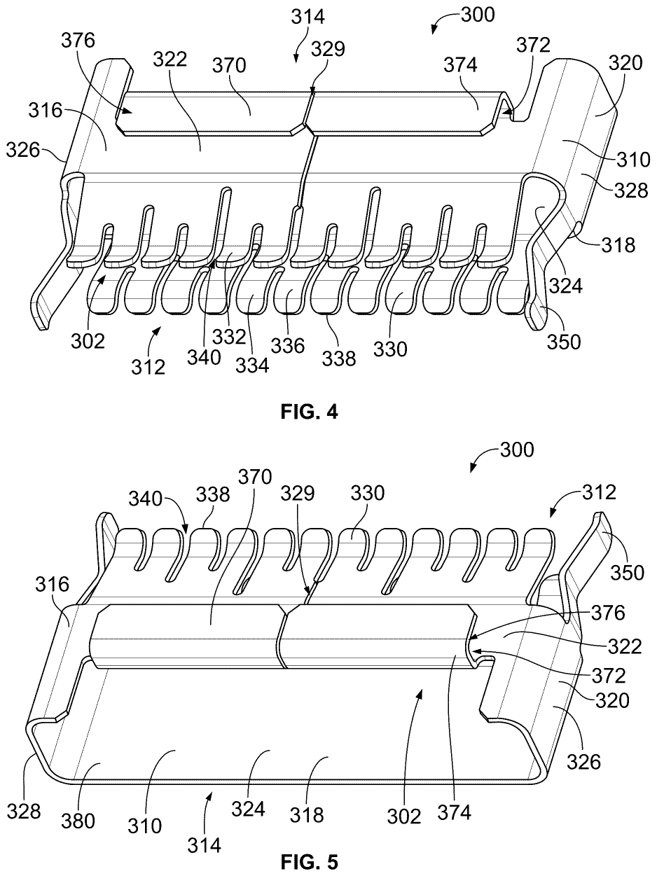

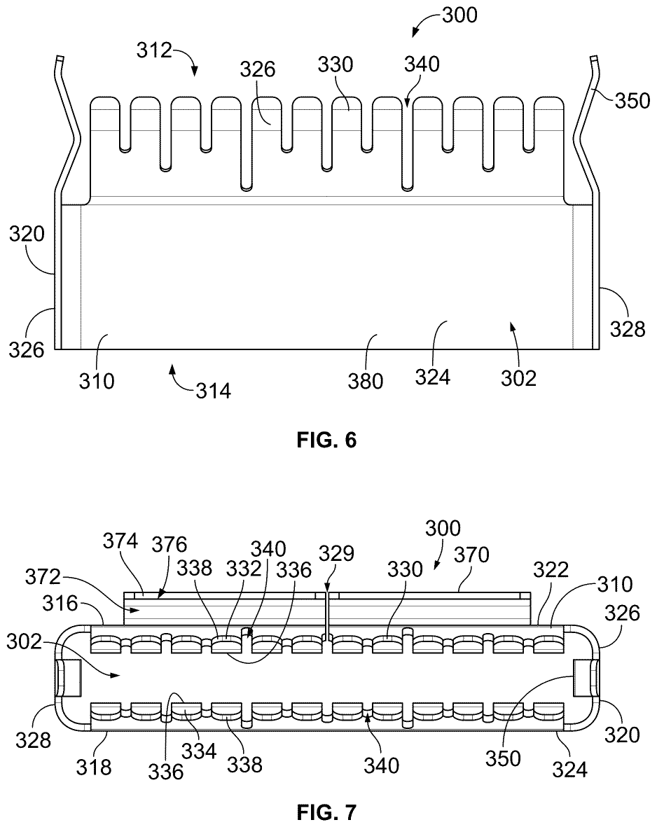

FIG. 4 is a front perspective view of the contact insert 300 in accordance with an exemplary embodiment. FIG. 5 is a front perspective view of the contact insert 300 in accordance with an exemplary embodiment. FIG. 6 is a top, partial sectional view of the contact insert 300 in accordance with an exemplary embodiment. FIG. 7 is a front view of the contact insert 300 in accordance with an exemplary embodiment. In an exemplary embodiment, the rear contact insert 400 (FIG. 2) is identical to the front contact insert 300 and like components may be identified with like reference numerals.

The contact insert 300 includes a contact body 310 forming a receptacle 302. The receptacle 302 is configured to receive the mating power terminal 110 (FIG. 1). The contact insert 300 includes contact beams 330 extending into the receptacle 302 to interface with the mating power terminal 110. In various embodiments, the contact insert 300 includes side contact beams 350 at opposite sides of the contact insert 300. However, the contact insert 300 may be provided without the side contact beams 350 in alternative embodiments. In various embodiments, the contact insert 300 includes an upper weld pad 370 and a lower weld pad 380. However, the contact insert 300 may be provided without the upper weld pad 370 and/or the lower weld pad 380 in alternative embodiments. The contact insert 300 may include other components or features in alternative embodiments.

In an exemplary embodiment, the contact body 310 is a stamped and formed body. In an exemplary embodiment, the contact body 310 extends between a front 312 and a rear 314. The contact body 310 includes a top 316 and a bottom 318. The contact body 310 includes sides 320 between the top 316 and the bottom 318. The contact body 310 includes walls along the top 316, the bottom 318, and the sides 320 to form the receptacle 302.

In an exemplary embodiment, the contact body 310 is a metal plate. For example, the contact body 310 may be a copper plate, aluminum plate, stainless steel plate, or other metal plate. The contact body 310 may be a stamped metal part. The contact body 310 has a thickness. The main body may have a uniform thickness, such as being stamped from a metal plate having parallel upper and lower surfaces defining the thickness that is then formed into a predetermined shape. In an exemplary embodiment, the contact body 310 is thinner than the main body 210. For example, the contact body 310 is stamped from a thinner metal plate than the main body 210. As such, the contact body 310 may be more easily formed into a predetermined shape. The dimensions and forming tolerance of the contact body 310 may be more easily controlled than the main body 210. The contact body 310 may be manufactured form a different material than the main body 210, such as being stamped from a different type of metal plate.

In an exemplary embodiment, the contact body 310 is bent or folded or otherwise formed into the box-shape to form the receptacle 302. The contact body 310 includes a plurality of walls forming the box-shaped structure to surround the receptacle 302, such as an upper contact body wall 322, a lower contact body wall 324, and side contact body walls 326, 328 extending between the upper and lower contact body walls 322, 324. The walls extend between the front 312 and the rear 314. The contact body 310 may include a seam 329, such as where the folded over edges meet. In the illustrated embodiment, the seam 329 is at the upper contact body wall 322, but may be at other locations in alternative embodiments.

The contact beams 330 are configured to interface with the mating power terminal 110. The contact beams 330 are deflectable. The contact beams 330 extend from the walls of the contact body 310, such as at the top 316 and the bottom 318. For example, the contact beams 330 may include upper contact beams 332 extending from the upper contact body wall 322 and lower contact beams 334 extending from the lower contact body wall 324. The contact beams 330 may extend along the receptacle 302 to interface with the mating power terminal 110 when the mating power terminal 110 is plugged into the receptacle 302. In an exemplary embodiment, the contact beams 330 are integral with the contact body 310. For example, the contact beams 330 are stamped and formed with the contact body 310. Each contact beam 330 includes a mating interface 336, such as at or proximate to a distal end 338 of the contact beam 330. The contact beam 330 may include a plating layer. For example, the contact beam 330 may include a plating layer at the mating interface 336 to improve or enhance mating. In various embodiments, the plating layer may be a silver plating layer.

In an exemplary embodiment, the contact beams 330 are separated by slots 340. The contact beams 330 are independently movable relative to each other because the contact beams 330 are separated by the slots 340. In an exemplary embodiment, the contact beams 330 define a lamella mating structure. For example, the contact beams 330 extend parallel to each other and define multiple points of contact with the mating power terminal 110. The contact beams 330 create a reliable electrical connection with low contact resistance. The multiple contact beams 330, which are independently movable, creates low insertion and withdrawal forces and high contact reliability for a high number of mating cycles. The fractal lamella geometry of the contact beams 330 provides sufficient contact independence to accommodate gap tolerances and creates a reliable contact interface, such as for vibration. The number of contact beams 330 may be changed by changing widths of the individual contact beams 330 or by changing the width of the contact insert 300 to allow greater or fewer contact beams 330.

In an exemplary embodiment, the slots 340 have different lengths to form different length contact beams 330. For example, the contact beams 330 have a branching structure defined by the different length slots 340. The branching structure forms contact beams 330 having different effective widths. For example, some branches may have singled contact beam widths, some branches may have double beam widths, some branches may have quadruple beam widths, and the like. The branching structure provides non-linear dampening, such as to distribute forces and provide vibration mitigation. The fractal contact beam geometry helps dampen vibration energy and lessen destructive impact of resonance. The branching structure allows the contact beams 330 to function as if having a tapered width. For example, the different length slots may define a tapered width for the contact beams 330.

In an exemplary embodiment, the contact body 310 may be imaged by a vision inspection system to determine that the size and/or shape of the contact insert 300 is within a particular tolerance. The stamping and forming of the contact body 310 may be tightly controlled and/or adjusted to a particular size, corresponding to a size (for example, thickness) of the mating power terminal 110. For example, the size of the gap between the contact beams 330 may be controlled to control the insertion force for inserting the mating power terminal 110 into the receptacle 302 and/or to control mated pressure to ensure a reliable electrical connection with the mating power terminal 110.

The side contact beams 350 are provided at the sides 320. For example, the side contact beams 350 extend from the side contact body walls 326, 328. The side contact beams 350 are configured to engage the side walls 266, 268 of the outer terminal body 250 to laterally position the contact insert 300 in the socket 260. For example, the side contact beams 350 may press outward against the side walls 266, 268. The side contact beams 350 provide vibration mitigation.

The upper weld pad 370 is provided at the top of the contact insert 300. The upper weld pad 370 may be planar. The upper weld pad 370 may be provided at or extend from the upper contact body wall 322. The upper weld pad 370 is configured to be welded to the upper wall 262 of the outer terminal body 250. In the illustrated embodiment, the upper contact body wall 322 is formed into a U-shaped structure forming a pocket 372. For example, the upper contact body wall 322 includes a tab 374 forming a hook 376 surrounding the pocket 372. The hook 376 may be forward facing. The pocket 372 is configured to receive the upper wall 262 of the outer terminal body 250. For example, the hook 376 is configured to hook around the edge of the upper wall 262. The upper weld pad 370 may be formed at the outer portion of the tab 374. In an exemplary embodiment, the upper weld pad 370 includes a plating layer to improve welding characteristics. For example, the upper weld pad 370 may include a tin plating layer.

The lower weld pad 380 is provided at the bottom of the contact insert 300. The lower weld pad 380 may be planar. The lower weld pad 380 may be provided at or extend from the lower contact body wall 322. The lower weld pad 380 is configured to be welded to the lower wall 262 of the outer terminal body 250. In an exemplary embodiment, the upper weld pad 370 is offset from the lower weld pad 380. For example, the upper weld pad 370 may be shifted forward relative to the lower weld pad 380 such that both the upper weld pad 370 and the lower weld pad 380 are accessible from above for welding. Other orientations are possible in alternative embodiments. In an exemplary embodiment, the lower weld pad 380 includes a plating layer to improve welding characteristics. For example, the lower weld pad 380 may include a tin plating layer.

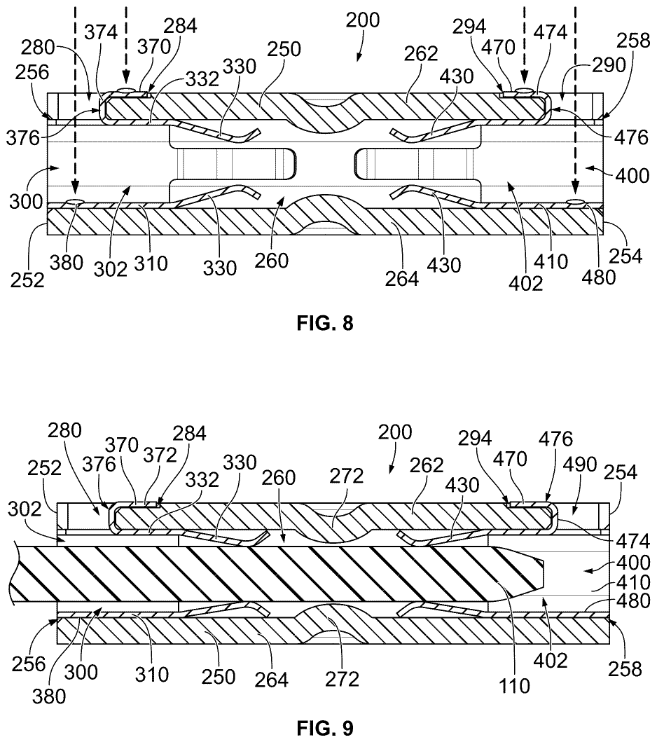

FIG. 8 is a cross-sectional view of the power terminal 200 in accordance with an exemplary embodiment. FIG. 9 is a cross-sectional view of the power terminal 200 in accordance with an exemplary embodiment showing the mating power terminal 110 mated with the power terminal 200. FIGS. 8 and 9 illustrate the front and rear contact inserts 300, 400 loaded unto the socket 260 of the outer terminal body 250. The front and rear contact inserts 300, 400 are configured to be electrically connected to the mating power terminal 110 when the mating power terminal 110 is plugged into the socket 260. In an exemplary embodiment, the outer terminal body 250 is pre-formed to form the socket 260 prior to receiving the contact inserts 300, 400.

In an exemplary embodiment, the dimples 272 extend into the socket 260 from the upper wall 262 and/or the lower wall 264. The dimples 272 are used to control a position of the mating power terminal 110 in the socket 260, such as to control a position of the mating power terminal 110 relative to the contact inserts 300, 400. The dimples 272 limit overstress of the contact beams 330, 430 of the contact inserts 300, 400, such as by controlling a vertical position of the mating power terminal 110 in the socket 260.

During assembly, the front contact insert 300 is loaded into the front opening 256 at the front end 252 of the outer terminal body 250. In an exemplary embodiment, the contact insert 300 is pre-formed prior to loading into the outer terminal body 250. As such, the contact insert 300 may be formed to precise manufacturing tolerances, such as to have a predetermined gap height for mating with the mating power terminal 110 and may be vision inspected prior to loading into the outer terminal body 250. The forming of the contact insert 300 is thus not dependent on the forming of the outer terminal body 250. When assembled, the contact body 310 is located in the socket 260. One or more of the walls of the contact body 310 may abut against one or more of the walls of the outer terminal body 250. The contact beams 330 are located in the socket 260 to interface with the mating power terminal 110 when loaded into the socket 260. The contact beams 330 may be angled inward, such as away from the upper wall 262 and the lower wall 264, to allow outward deflection of the contact beams 330 when the mating power terminal 110 is plugged into the receptacle 302 and the socket 260.

The front contact insert 300 is coupled to the outer terminal body 250. For example, the front contact insert 300 may be welded to the outer terminal body 250. In an exemplary embodiment, the upper weld pad 370 is configured to be welded to the upper wall 262. For example, the upper tab 374 of the upper contact body wall 322 is received in the front slot 280 at the front end 252 of the outer terminal body 250. The hook 376 hooks around the front edge of the upper wall 262. The upper weld pad 370 is received in the front pocket 284. The upper weld pad 370 extends along the top or the outer surface of the upper wall 262. The upper weld pad 370 may be welded to the upper wall 262 from above, such as being laser welded to the upper wall 262. In an exemplary embodiment, the lower weld pad 380 is configured to be welded to the lower wall 264. The lower weld pad 380 extends along the inner surface of the lower wall 264. The lower weld pad 380 may be welded to the lower wall 264 from above, such as being laser welded to the lower wall 264. In an exemplary embodiment, the upper weld pad 370 is offset from the lower weld pad 380. For example, the upper weld pad 370 may be shifted forward relative to the lower weld pad 380 such that both the upper weld pad 370 and the lower weld pad 380 are accessible from above for welding. Other orientations are possible in alternative embodiments.

During assembly, the rear contact insert 400 is loaded into the rear opening 258 at the rear end 254 of the outer terminal body 250. In an exemplary embodiment, the contact insert 400 is pre-formed prior to loading into the outer terminal body 250. As such, the contact insert 300 may be formed to precise manufacturing tolerances, such as to have a predetermined gap height for mating with the mating power terminal 110 and may be vision inspected prior to loading into the outer terminal body 250. The forming of the contact insert 300 is thus not dependent on the forming of the outer terminal body 250. When assembled, a contact body 410 of the rear contact insert 400 is located in the socket 260. One or more of the walls of the contact body 410 may abut against one or more of the walls of the outer terminal body 250. Contact beams 430 of the contact insert 400 are located in the socket 260 to interface with the mating power terminal 110 when loaded into the socket 260. The contact beams 430 may be angled inward, such as away from the upper wall 262 and the lower wall 264, to allow outward deflection of the contact beams 430 when the mating power terminal 110 is plugged into a receptacle 402 of the contact insert 400.

The rear contact insert 400 is coupled to the outer terminal body 250. For example, the rear contact insert 400 may be welded to the outer terminal body 250. In an exemplary embodiment, an upper weld pad 470 is configured to be welded to the upper wall 262. For example, an upper tab 474 of the upper contact body wall 322 is received in the rear slot 290 at the rear end 254 of the outer terminal body 250. A hook 476 hooks around the rear edge of the upper wall 262. The upper weld pad 470 is received in the rear pocket 294. The upper weld pad 470 extends along the top or the outer surface of the upper wall 262. The upper weld pad 470 may be welded to the upper wall 262 from above, such as being laser welded to the upper wall 262. In an exemplary embodiment, a lower weld pad 480 is configured to be welded to the lower wall 264. The lower weld pad 480 extends along the inner surface of the lower wall 264. The lower weld pad 480 may be welded to the lower wall 264 from above, such as being laser welded to the lower wall 264. In an exemplary embodiment, the upper weld pad 470 is offset from the lower weld pad 480. For example, the upper weld pad 470 may be shifted forward relative to the lower weld pad 480 such that both the upper weld pad 470 and the lower weld pad 480 are accessible from above for welding. Other orientations are possible in alternative embodiments.

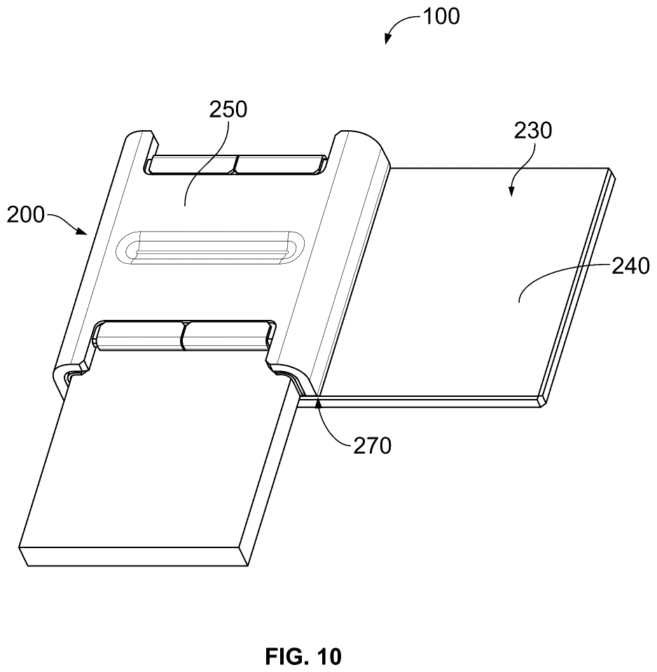

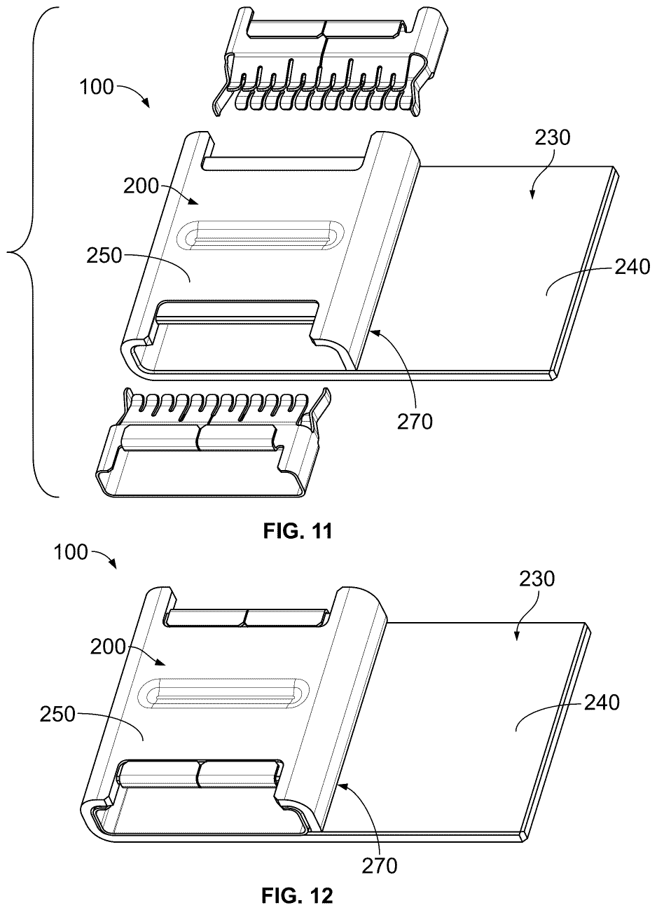

FIG. 10 illustrates the electrical connector system 100 including the power terminal 200 in accordance with an exemplary embodiment. FIG. 11 is a front perspective, exploded view of the power terminal 200 in accordance with an exemplary embodiment. FIG. 12 is a front perspective, assembled view of the power terminal 200 in accordance with an exemplary embodiment.

The power terminal 200 is similar to the power terminal shown in FIGS. 1-3. However, the power terminal 200 shown in FIGS. 10-12 illustrate the terminating portion 230 extending from the side of the power terminal 200 rather than the rear of the power terminal 200. For example, the weld pad 240 is provided at the side and the outer terminal body 250 is folded over into the box shape such that the seam 270 is located at the weld pad 240.

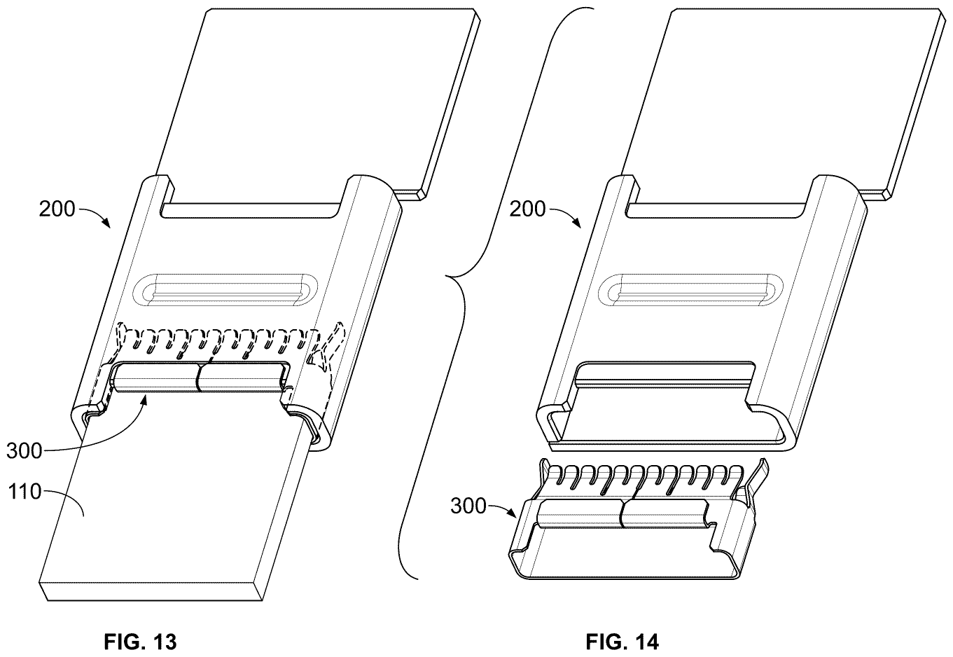

FIG. 13 is a front perspective, exploded view of the power terminal 200 in accordance with an exemplary embodiment. FIG. 14 is a front perspective, assembled view of the power terminal 200 in accordance with an exemplary embodiment.

The power terminal 200 is similar to the power terminal shown in FIGS. 1-3. However, the power terminal 200 shown in FIGS. 13-14 does not include the rear contact insert 400. Rather, the power terminal 200 only includes the front contact insert 300. As such, the power terminal 200 may be made at less cost by eliminating a component. However, such power terminal 200 has fewer points of contact with the mating power terminal 110.

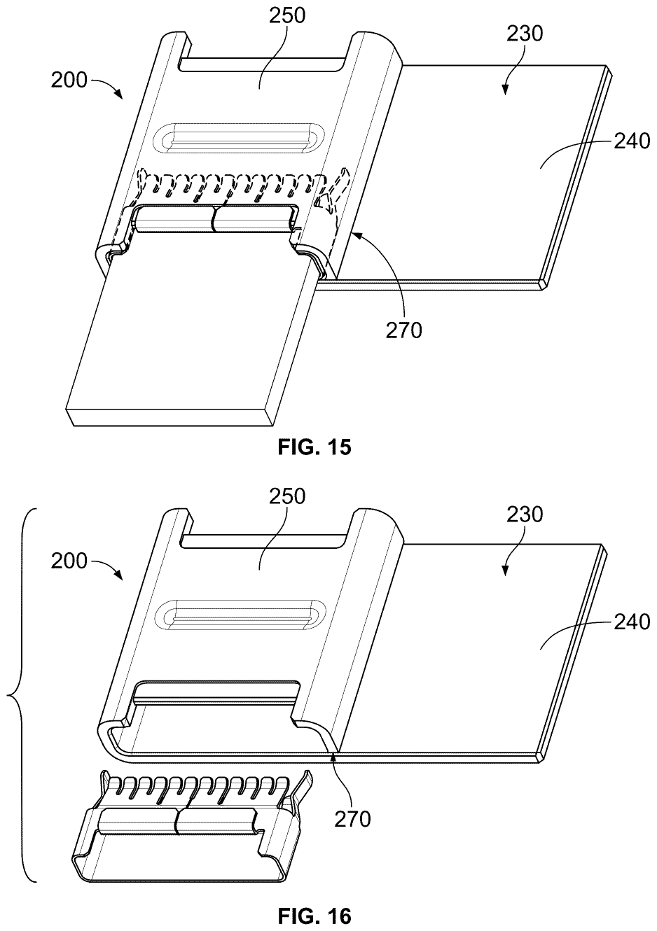

FIG. 15 is a front perspective, exploded view of the power terminal 200 in accordance with an exemplary embodiment. FIG. 16 is a front perspective, assembled view of the power terminal 200 in accordance with an exemplary embodiment.

The power terminal 200 is similar to the power terminal shown in FIGS. 13-14. However, the power terminal 200 shown in FIGS. 15-16 illustrate the terminating portion 230 extending from the side of the power terminal 200 rather than the rear of the power terminal 200. For example, the weld pad 240 is provided at the side and the outer terminal body 250 is folded over into the box shape such that the seam 270 is located at the weld pad 240.

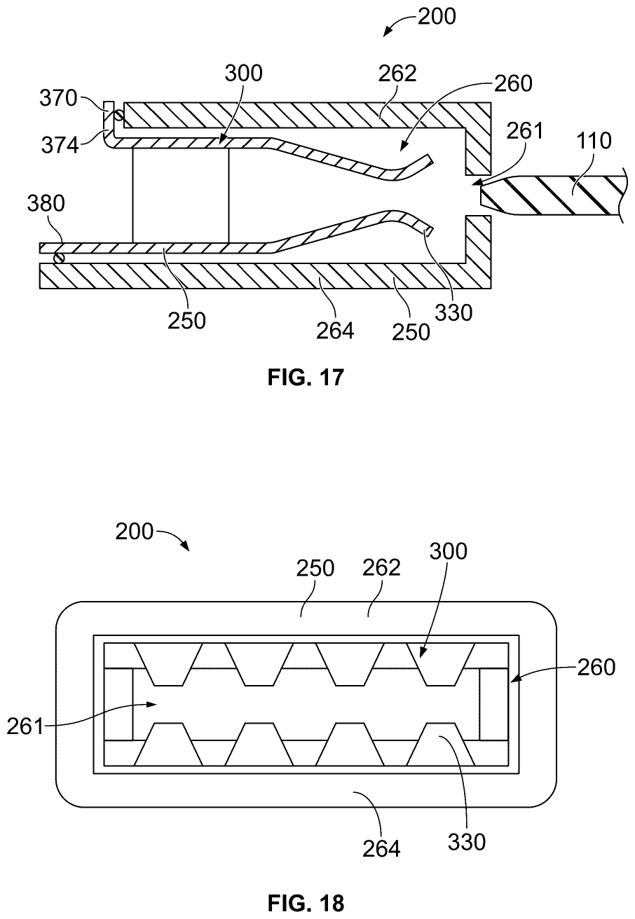

FIG. 17 is a side cross-sectional view of the power terminal 200 in accordance with an exemplary embodiment. FIG. 18 is an end cross-sectional view of the power terminal 200 in accordance with an exemplary embodiment. In the illustrated embodiment, the outer terminal body 250 includes a mating slot 261 at the mating end configured to receive the mating power terminal 110. The contact beams 330 are arranged in the socket 260 to mate with the mating power terminal 110 when the mating power terminal 110 is plugged into the socket 260.

The contact insert 300 is coupled to the outer terminal body 250. For example, the contact insert 300 may be welded to the outer terminal body 250. In an exemplary embodiment, the upper weld pad 370 is configured to be welded to the upper wall 262, such as at the distal edge of the upper wall 262. In the illustrated embodiment, the upper tab 374 is bent 90° into an L-shape rather than being bent into the U-shape or the hook. The upper weld pad 370 may be welded to the upper wall 262 from above or from behind. In an exemplary embodiment, the lower weld pad 380 is configured to be welded to the lower wall 264. The lower weld pad 380 may be welded to the lower wall 264 from above, such as being laser welded to the lower wall 264. In an exemplary embodiment, the upper weld pad 370 is offset from the lower weld pad 380. For example, the upper weld pad 370 may be shifted forward relative to the lower weld pad 380 such that both the upper weld pad 370 and the lower weld pad 380 are accessible from above for welding. Other orientations are possible in alternative embodiments.

It is to be understood that the above description is intended to be illustrative, and not restrictive. For example, the above-described embodiments (and/or aspects thereof) may be used in combination with each other. In addition, many modifications may be made to adapt a particular situation or material to the teachings of the invention without departing from its scope. Dimensions, types of materials, orientations of the various components, and the number and positions of the various components described herein are intended to define parameters of certain embodiments, and are by no means limiting and are merely exemplary embodiments. Many other embodiments and modifications within the spirit and scope of the claims will be apparent to those of skill in the art upon reviewing the above description. The scope of the invention should, therefore, be determined with reference to the appended claims, along with the full scope of equivalents to which such claims are entitled. In the appended claims, the terms “including” and “in which” are used as the plain-English equivalents of the respective terms “comprising” and “wherein.” Moreover, in the following claims, the terms “first,” “second,” and “third,” etc. are used merely as labels, and are not intended to impose numerical requirements on their objects. Further, the limitations of the following claims are not written in means-plus-function format and are not intended to be interpreted based on 35 U.S.C. § 112(f), unless and until such claim limitations expressly use the phrase “means for” followed by a statement of function void of further structure.

What is claimed is:

1. A power terminal comprising:
a main body extending between a front and a rear;
a terminating portion extending from the main body configured to be terminated to a power conductor;
an outer terminal body extending from the main body, the outer terminal body having an upper wall, a lower wall, and side walls forming a socket, the outer terminal body including a front opening open to the socket, the front opening configured to receive a mating power terminal; and
a contact insert received in the socket, the contact insert including a contact body electrically connected to the outer terminal body, the contact body forming a receptacle configured to receive the mating power terminal, the contact insert including contact beams extending into the receptacle to interface with the mating power terminal to electrically connect the outer terminal body to the mating power terminal;
wherein the outer terminal body is pre-formed to form the socket prior to receiving the contact insert and wherein the contact insert is pre-formed prior to loading into the socket.

2. The power terminal of claim 1, wherein the outer terminal body has a first thickness and the contact body has a second thickness thinner than the first thickness.

3. The power terminal of claim 1, wherein the contact body includes an upper contact body wall and a lower contact body wall, the contact body including upper contact beams extending from the upper contact body wall and lower contact beams extending from the lower contact body wall.

4. The power terminal of claim 1, wherein the contact body includes an upper weld pad welded to the upper wall of the outer terminal body and a lower weld pad welded to the lower wall of the outer terminal body.

5. The power terminal of claim 4, wherein the upper weld pad is offset from the lower weld pad such that both the upper weld pad and the lower weld pad are accessible from above for welding.

6. The power terminal of claim 4, wherein the upper weld pad includes a plating layer and the lower weld pad includes a plating layer.

7. The power terminal of claim 1, wherein the outer terminal body includes a seam extending between the front and the rear, the seam being provided at one of the upper wall, the lower wall, or one of the side walls.

8. The power terminal of claim 1, wherein the contact insert includes side contact beams, the side contact beams engaging the side walls of the outer terminal body to laterally position the contact insert in the socket.

9. The power terminal of claim 1, wherein the outer terminal body includes a slot at the front, the contact insert received in the slot.

10. The power terminal of claim 1, wherein the terminating portion extends rearward of the outer terminal body to the rear of the main body.

11. The power terminal of claim 1, wherein the terminating portion extends laterally from the outer terminal body to a first side of the socket.

12. The power terminal of claim 1, wherein the terminating portion includes a weld pad.

13. The power terminal of claim 1, wherein the contact insert is a front contact insert, the power terminal further comprising a rear contact insert received in the socket, the rear contact insert including a rear contact body electrically connected to the outer terminal body, the rear contact body forming a rear receptacle configured to receive the mating power terminal, the rear contact insert including rear contact beams extending into the rear receptacle to interface with the mating power terminal to electrically connect the outer terminal body to the mating power terminal, wherein the rear contact insert is pre-formed prior to loading into the socket.

14. The power terminal of claim 1, wherein the contact beams are separated by slots such that the contact beams are independently movable relative to each other.

15. The power terminal of claim 14, wherein the slots have different lengths to form different length contact beams.

16. The power terminal of claim 1, wherein each contact beam includes a mating interface, the contact beam including a plating layer at the mating interface.

17. A power terminal comprising:
a main body extending between a front and a rear;
a terminating portion extending from the main body configured to be terminated to a power conductor;
an outer terminal body extending from the main body, the outer terminal body having an upper wall, a lower wall, and side walls forming a socket, the outer terminal body including a front opening open to the socket at the front and a rear opening open to the socket at the rear, the front opening configured to receive a mating power terminal;
a front contact insert received in the socket, the front contact insert including a front contact body electrically connected to the outer terminal body, the front contact body forming a front receptacle configured to receive the mating power terminal, the front contact insert including front contact beams extending into the front receptacle to interface with the mating power terminal to electrically connect the outer terminal body to the mating power terminal; and
a rear contact insert received in the socket, the rear contact insert including a rear contact body electrically connected to the outer terminal body, the rear contact body forming a rear receptacle configured to receive the mating power terminal, the rear contact insert including rear contact beams extending into the rear receptacle to interface with the mating power terminal to electrically connect the outer terminal body to the mating power terminal;
wherein the outer terminal body is pre-formed to form the socket prior to receiving the front and rear contact inserts, wherein the front contact insert is pre-formed prior to loading into the socket, and wherein the rear contact insert is pre-formed prior to loading into the socket.

18. A method of forming a power terminal comprising:
providing a main body with a terminating portion extending from the main body configured to be terminated to a power conductor, the main body being a metal structure, the main body extending between a front and a rear;
forming an outer terminal body from the main body by a forming process to define a socket, the outer terminal body having an upper wall, a lower wall, and side walls surrounding the socket, the outer terminal body including a front opening open to the socket configured to receive a mating power terminal; and
providing a contact body including contact beams;
forming the contact body into a contact insert having a receptacle configured to receive the mating power terminal, the contact beams extending into the receptacle to interface with the mating power terminal;
loading the formed contact insert into the socket of the formed outer terminal body; and
electrically connecting the contact insert to the outer body terminal to electrically connect the outer terminal body to the mating power terminal.

19. The method of claim 18, further comprising performing vision inspection of the formed contact insert prior to loading the formed contact insert into the socket.

20. The method of claim 18, wherein said electrically connecting the contact insert to the outer body terminal comprising laser welding an upper weld pad of the contact body to the upper wall and laser welding a lower weld pad of the contact body to the lower wall.
